(19) United States
(12) Patent Application Publication
(10) Pub. No.: US 2015/0338627 A1
(43) Pub. Date: Nov. 26, 2015

(54) APPARATUS AND METHOD FOR ATOMIC FORCE, NEAR-FIELD SCANNING OPTICAL MICROSCOPY

(71) Applicant: Multiprobe, Inc., Santa Barbara, CA (US)

(72) Inventors: Andrew Norman Erickson, Santa Barbara, CA (US); Stephen Bradley Ippolito, Saint Petersburg, FL (US); Anton Lewis Riley, Santa Barbara, CA (US)

(21) Appl. No.: 14/719,203

(22) Filed: May 21, 2015

Related U.S. Application Data
(60) Provisional application No. 62/001,823, filed on May 22, 2014.

(51) Int. Cl. G02B 21/00; G02B 6/26

(52) U.S. Cl. CPC G02B 21/0032; G02B 6/262

(57) ABSTRACT

A near-field optic has a high refractive index waveguide with a planar far field facet more than half of a wavelength across for coupling propagating light and a near field facet with the near field zone of the waveguide supporting only the fundamental optical mode in each polarization. A tapered waveguide section extends from the near field facet to transform the fundamental optical mode. A cantilever supports the tapered waveguide section.

### REFERENCES TO RELATED APPLICATIONS

This application claims priority of U.S. Provisional Application Ser. No. 62/001,823 entitled Scanning Optical Microscopy filed on May 22, 2014, the disclosure of which is incorporated herein by reference.

### BACKGROUND INFORMATION

1. Field

Embodiments of the disclosure relate generally to the field of high resolution optical microscopy more particularly a near field optic incorporating a high refractive index semiconductor waveguide with a tapered section disposed at the end of a cantilever to provide spatial confinement up the ultimate diffraction limit with minimal angular semi-aperture and near unity efficiency with optional addition of an optical antenna at the tip of the waveguide employing a bisected gold nanorod forming a dipole optical antenna and gap.

1. Background

For a few centuries, optical microscopists have steadily improved the spatial resolution and efficiency of coupling light between small-scale objects and large-scale systems, such as the human eye.[1] The diffraction of light ultimately limits the spatial resolution of an optical microscope that only couples propagating fields, to half of a wavelength. [2] Visible light microscopes that perform with high efficiency and diffraction limited spatial resolution have been mass produced for more than a century.[3]

Near-Field optics operate at distances less than a wavelength from the surface of an object within evanescent fields that permit spatial resolutions beyond the diffraction limit.[4] As is known in the art of near-field optics, evanescent fields have at least one imaginary wavevector component and can therefore have other real wavevector components that exceed the wavevector magnitude. Introducing an optic into the near-field of the object can scatter these evanescent fields into propagating fields. The propagating fields may then be collected in the far field by conventional means and thereby generate spatial resolutions beyond the diffraction limit. The object may be absorbing, scattering, emitting, or non-interacting, so the optical field solutions associated with the near-field optic are strongly dependent on the object itself. In general, the near-field optic is designed to couple large wavevector evanescent and propagating fields near the object with small lateral wavevector propagating fields at the large-scale system.

The earliest examples of near-field optics more than century ago were the immersion technique, where the object is immersed in a high refractive index liquid, such as water or oil.[9] Since the optical frequency in a linear material remains the same, slowing down the speed of light with a high refractive index material reduces its effective wavelength. Solid optics composed of a high refractive index material with a planar interface have also been used for near-field microscopy for more than half a century.[10] Reducing the wavelength of propagating fields within the solid near-field optic by increasing its refractive index permits coupling with the evanescent fields near the object. The spatial resolution improvement of these immersion techniques is ultimately limited to the ratio of refractive indexes of the optic and object near-field. Two decades ago, a spherical surface was added to the solid optic to form a Solid Immersion Lens (SIL), which enable these ultimate spatial resolutions. [11]

The material for near-field optics may be dielectrics, semiconductors, conductors, or a combination thereof. Dielectrics, such as glass and plastic, are the material of choice for large-scale optics, because of their manufacturability and low transmission losses. However, for near-field optics, higher refractive index materials, such as semiconductors, provide greater wavelength reduction, maintain reasonable transmission efficiency, and attract photons more efficiently in a qualitative sense.[5] Silicon, for example, has a refractive index of 3.5 at a free space wavelength of 1300 nanometers, and for micrometer-scale near-field optics its transmission losses are reasonable down to a free space wavelength of 700 nanometers.[6] At optical frequencies, metals do not behave as perfect conductors, but some demonstrate reasonably low absorption loss at interaction lengths of less than 100 nm and repel photons efficiently in a qualitative sense.[7] Monocrystalline gold, for example, has been shown to be the material of choice at infrared and visible wavelengths due to its noble nature and low loss.[8]

Early optical microscopes produced images in a parallel manner, where an entire field of view was acquired simultaneously, often by a human eye or strip of film. [12] The many spatial modes of a common parallel optical microscope overlap strongly between the object and image planes, but in the absence of significant system aberration and material non-linearity the spatial modes become well isolated again at the image plane. More than half a century ago, the Scanning Optical Microscope (SOM) was developed and produced images in a serial manner, where pixels in the field of view are acquired sequentially during a scan of the object. [13] The invention of the laser, a spatially well confined light source, made flying spot and confocal SOM practical in many applications. [14] Many SOM designs utilize only one spatial mode of the optical system per pixel, which represented a significant change in methodology.

The concept of improving the spatial resolution of microscopy beyond the diffraction limit with an aperture, as the near-field optic, was proposed about a century ago.[15] The sub-wavelength diameter aperture is scanned in the optical near-field of the object, and is thus termed aperture Near-field Scanning Optical Microscopy (NSOM).[16] Evanescent fields on the object side of the aperture are scattered into propagating fields on the other side of the aperture. Three decades ago, an order of magnitude improvement in spatial resolution was demonstrated at visible wavelengths with aperture NSOM. [17] The significant improvement in spatial resolution with aperture NSOM designs is accompanied by a decrease in efficiency by many orders of magnitude, so it is not widely adopted outside of academia. The decrease in efficiency from having a small area aperture in a large area optical field is commonly compounded by inefficient metallic waveguide designs placed before the aperture. A typical state of the art design of this type comprises an optical fiber that has been drawn into an approximately conical taper with a final tip radius of tens to hundreds of nanometers. The fiber is then coated with a metal layer in order to form a near-field aperture at the apex of the taper. Polycrystalline metal coated fibers with conical tapers exhibit high power losses to heat in the coating, and only transmit through optical tunneling with modal cutoff before the aperture. The heat absorption in the coating limits the input power that may be safely used before damage to the coating results.

Apertureless NSOM is a derivative of aperture NSOM that uses refractive index contrast to spatially confine light in the waveguide instead of a metal coating and aperture. [18] Since fiber optics were developed for long distance communications, the efficiency of such waveguides can be near unity for the length scales of microscopy. However, the optical fiber used to fabricate standard NSOM probes has a relatively low refractive index, and therefore provide little benefit in spatial confinement. Apertureless NSOM tapers also usually extend into the near-field, that is, the taper cross-section is significantly less than the wavelength of light being confined. Due to the squeezing of the propagating light into a near-field confinement without the aid of a large refractive index mismatch to confine the light, the propagating light is either radiated from the taper as loss and possibly background or refracted back up the optical fiber towards the source. Therefore coupling across the conical taper face introduces a large background (reflected or unconfined) signal, making spatial isolation and analysis difficult and the coupling efficiencies are poor, often below parts per million. The simple reason tapered fibers are in standard use is that coupling to the sources, detectors, and other optics is provided with the fiber connector. This type of thinking has led to limited development of a more effective NSOM design. In addition to sacrifices in spatial confinement and therefore resolution, the fibers are also difficult to position and scan in the near-field. As a requirement for NSOM however, methods for controlling the spacing as in scanned probe microscopy have been difficult to perform. Cantilevered fibers, that is fibers whose tapered ends are bent to form a cantilever, or shear force feedback are the two primary methodologies for NSOM. Neither of these techniques performs well as a scanned probe microscope. There is significant motivation to overcome the limitations of the current state of the art both in making an NSOM which is more efficient in terms of coupling efficiency, resolution, and ease of use all of which are provided in the present invention.

The concept of improving the spatial resolution of microscopy beyond the diffraction limit with an antenna, as the near-field optic, was also proposed about a century ago. [19] In an optical antenna, light is absorbed via creation of plamon polaritons in a metal antenna to which light is coupled. The optical antenna is ideally composed of a monocrystalline noble metal to minimize losses at optical frequencies which are in the range of hundreds of terahertz. The geometric shape of the optical antenna strongly influences the propagating and evanescent fields that it couples, and is commonly a monopole or dipole design using sharp tips, nanoparticles, or patterned planar metal. The first demonstration of antenna NSOM more than a decade ago, used a solid gold tip and improved the spatial resolution with visible light by a factor of twenty relative to the diffraction limit, while enhancing the optical field by a factor of a thousand. [20] In current dipole designs, only about half of the power is dissipated non-radiatively as heat in the antenna, which is a tremendous improvement over aperture NSOM efficiencies with similar spatial confinement.[7] Resonant antenna designs show significantly higher field enhancements and efficiencies than non-resonant designs. In a resonant design antenna, the geometry of each pole is chosen to match a quarter wavelength of light. However, since metals do not behave as perfect conductors at optical frequencies two effects result: First the actual antenna length for resonance is shorter than a quarter wavelength. Second, since losses scale with interaction length, strong focusing of light to the smallest diffraction limited spot is necessary to maintain maximum efficiency, that is most of the squeezing of light should be done prior to coupling to the antenna. In order to increase the gain of an optical antenna, a larger structure is required. High gain optical antennas are thus impractical in most applications due to losses from conduction resistance. The low gain optical antenna design disposed on the facet of a near-field optic in one embodiment of the present invention provides strong coupling efficiency between a diffraction limited near-field focus that matches the optical cross-section of the antenna.

The practicality of a near-field optic to a wide variety of applications is dictated by its spatial confinement, coupling efficiency, angular semi-aperture, and manipulation. The success of a practical, high performance and useful NSOM design requires that the near-field element be small enough to be able to be brought within the evanescent field coupling distance of the object and provide near-field confinement of the light with high efficiency. Atomic Force Microscopy (AFM) manipulation with cantilevered probes is much simpler to use than the shear-force feedback methods employed in early NSOM, and thus AFM adaptation has been demonstrated on most near-field optic types, including SIL, aperture NSOM, and antenna NSOM.[21-30] As previously mentioned, aperture NSOM is impractical in most applications, because of its very low coupling efficiency. Decreasing the angular semi-aperture or size of the near-field facet of a SIL significantly reduces both its spatial confinement and coupling efficiency, so it is only practical in applications where most of the angular semi-aperture is available. Shaping the spherical surface of the SIL is also challenging from a fabrication cost perspective, and tends to drive its size up to the millimeter scale. SIL microscopy significantly improves the spatial confinement and coupling efficiency between nanometer-scale objects, such as quantum dots, and large-scale systems, but is still bounded by the diffraction limit.[31] Therefore, antenna NSOM and its derivatives are the best solution for most applications requiring the highest resolution and efficiency.

A hybrid NSOM design with a SIL and an antenna was proposed to create diffraction limited spatial confinement before reaching the antenna, but this design was never demonstrated and only overcomes one of the previously mentioned limitations associated with a SIL.[32] Another hybrid NSOM design with an aperture and an antenna fabricated on an AFM cantilever demonstrated significantly higher efficiency than comparable aperture NSOM, but significantly lower efficiency than standard antenna NSOM, due to losses in the waveguide, aperture, and antenna composed of polycrystalline aluminum.[29-30] A hybrid NSOM design called a Campanile with a partially coated waveguide and an antenna at the end of a glass optical fiber demonstrated spatial resolution improvement in one lateral direction but did not achieve maximum efficiency due to losses in the waveguide coating and antenna composed of polycrystalline gold.[33].

### REFERENCES

[1] http://en.wikipedia.org/wiki/Optical_microscope
[2] http://en.wikipedia.org/wiki/Diffraction-limited_system
[3] http://micro.magnet.fsu.edu/optics/timeline/people/abbe.html
[4] http://en.wikipedia.org/wiki/Evanescent_wave
[5] K. Koyama, M. Yoshita, M. Baba, T. Suemoto, H. Akiyama, “High collection efficiency in fluorescence microscopy with a solid immersion lens,” Applied Physics Letters 75 (1999): 1667.
[6] E. D. Palik, Handbook of Optical Constants of Solids (Academic Press, Boston, 1985).
[7] P. Biagioni, J. Huang, B. Hecht, “Nanoantennas for visible and infrared radiation,” Reports on Progress in Physics 75 (2012): 024402.
[8] J. Huang, V. Callegari, P. Geisler, C. Brüning, J. Kern, J. C. Prangsma, X. Wu, T. Feichtner, J. Ziegler, P. Weinmann, M. Kamp, A. Forche, P. Biagioni, U. Sennhauser, B. Hecht, “Atomically flat single-crystalline gold nanostructures for plasmonic nanocircuitry,” Nature Communications 1 (2010): 150.
[9] http://www.smecc.org/history_of_oil_immersion_lenses.htm
[10] C. W. McCutchen, “Optical Systems for Observing Surface Topography by Frustrated Total Internal Reflection and by Interference,” Review of Scientific Instruments 35 (1964): 1340.
[11] S. M. Mansfield, G. S. Kino, “Solid immersion microscope,” Applied Physics Letters 57 (1990): 2615.
[12] http://en.wikipedia.org/wiki/Optical_microscope
[13] http://en.wikipedia.org/wiki/Confocal_microscopy
[14] C. N. Potter, D. E. Sawyer, “A Flying-Spot Scanner,” Review of Scientific Instruments 39 (1968): 180.
[15] E. Synge, “A suggested method for extending microscopic resolution into the ultra-microscopic region,” Philosophical Magazine 6 (1928): 356.
[16] http://en.wikipedia.org/wiki/Near-field_scanning_optical_microscope
[17] D. W. Pohl, W. Denk, M. Lanz, “Optical stethoscopy: Image recording with resolution λ/20,” Applied Physics Letters 44 (1984): 651.
[18] L. Novotny, B. Hecht, Principles of Nano-Optics, 1st ed. (Cambridge University Press, New York, 2006).
[19] L. Novotny, “From near-field optics to optical antennas,” Physics Today 64, 7 (2011): 47.
[20] E. J. Sanchez, L. Novotny, X. S. Xie, “Near-Field Fluorescence Microscopy Based on Two-Photon Excitation with Metal Tips,” Physical Review Letters 82 (1999): 4014.
[21] http://www.google.com/patents/US6441359
[22] L. P. Ghislain, V. B. Elings, “Near-field scanning solid immersion microscope,” Applied Physics Letters 72 (1998): 2779.
[23] D. A. Fletcher, K. B. Crozier, C. F. Quate, G. S. Kino, K. E. Goodson, D. Simanovskii, D. V. Palanker, “Near-field infrared imaging with a microfabricated solid immersion lens,” Applied Physics Letters 77 (2000): 2109.
[24] http://www.google.com/patents/US5354985
[25] R. Eckert, J. M. Freyland, H. Gersen, H. Heinzelmann, G. Schürmann, W. Noell, U. Staufer, N. F. de Rooij, “Near-field fluorescence imaging with 32 nm resolution based on microfabricated cantilevered probes,” Applied Physics Letters 77 (2000): 3695.
[26] J. R. Krogmeier, R. C. Dunn, “Focused ion beam modification of atomic force microscopy tips for near-field scanning optical microscopy,” Applied Physics Letters 79 (2001): 4494.
[27] http://www.nanonics.co.il/products/spm-probes-and-nanotools/nsom-probes/fiber-probe-optical-fiber-nsom-probes.html
[28] J. N. Farahani, D. W. Pohl, H.-J. Eisler, B. Hecht, “Single Quantum Dot Coupled to a Scanning Optical Antenna: A Tunable Superemitter,” Physical Review Letters 95 (2005): 017402.
[29] L. Wang, X. Xu, “High transmission nanoscale bowtie-shaped aperture probe for near-field optical imaging,” Applied Physics Letters 90 (2007): 261105.
[30] R. Guo, E. C. Kinzel, Y. Li, S. M. Uppuluri, A. Raman, X. Xu, “Three-dimensional mapping of optical near field of a nanoscale bowtie antenna,” Optics Express 18 (2010): 4961.
[31] Z. Liu, B. B. Goldberg, S. B. Ippolito, A. N. Vamivakas, M. S. Ünlü, R. P. Mirin, “High resolution, high collection efficiency in numerical aperture increasing lens microscopy of individual quantum dots,” Applied Physics Letters 87 (2005) 071905.
[32] B. B. Goldberg, S. B. Ippolito, L. Novotny, Z. Liu, M. S. Ünlü, “Immersion Lens Microscopy of Photonic Nanostructures and Quantum Dots,” IEEE Journal of Selected Topics in Quantum Electronics 8 (2002): 1051.
[33] W. Bao, M. Melli, N. Caselli, F. Riboli, D. S. Wiersma, M. Staffaroni, H. Choo, D. F. Ogletree, S. Aloni, J. Bokor, S. Cabrini, F. Intonti, M. B. Salmeron, E. Yablonovitch, P. J. Schuck, A. Weber-Bargioni, “Mapping Local Charge Recombination Heterogeneity by Multidimensional Nanospectroscopic Imaging,” Science 338 (2012): 1317.
[34] http://en.wikipedia.org/wiki/Etching_%28microfabrication%29

It is therefore desirable to provide an optical microscopy system in which a near-field optic converts the free space beam with a diameter of several wavelengths to a diffraction limited spot size while simultaneously providing small semi-aperture and ease of manipulation. It is also desirable to further provide an optical antenna on the near field facet of a the near-field optic in order to maximize the overall coupling efficiency

### SUMMARY

Embodiments described herein disclose a near-field optic having a high refractive index waveguide with a planar far field facet more than half of a wavelength across for coupling propagating light, the facet in the near-field supporting only the fundamental optical mode. A tapered waveguide section extends from the near field facet to transform the fundamental optical mode. A cantilever supports the tapered waveguide section.

The features, functions, and advantages that have been discussed can be achieved independently in various embodiments of the present invention or may be combined in yet other embodiments further details of which can be seen with reference to the following description and drawings.

### BRIEF DESCRIPTION OF THE DRAWINGS

FIG. 1A is a side view of a prior art AFM probe showing cantilever mounting and standard profile;

FIG. 1B is a side view of an AFM probe modified as described with respect to the first embodiment of a near field optic;

FIG. 1C is a bottom view of the near field facet;

FIG. 2A is a side view of an embodiment of a near field optic;

FIG. 2B is a side view of an alternative embodiment of a near field optic;

FIG. 2C is an additional embodiment of a near field optic with alternative support;

FIG. 3A is a side view of a standard AFM taper at the tip;

FIG. 3B is a side view of a first modified taper;

FIG. 3C is a side view of a second modified taper;

FIG. 4 is a bottom view of the near field facet with a dipole optical antenna;

FIGS. 5A-5P are schematic views of process steps for fabrication of a near field optic;

FIGS. 5Q-5S are alternative optical antenna embodiments;

FIGS. 6A-6C are a representation of a Finite Difference Time Domain (FDTD) simulation of a near field optic of the embodiments disclosed ; and,

FIGS. 7A and 7B are a schematic representation of a method for localization using far-field optics in an SOM as in the prior art and then supplementing with near-field optics, as defined in the embodiments herein.

### DETAILED DESCRIPTION

The embodiments described herein provide a first element where light is converted from free space propagation to near-field confinement. The near-field optic converts the free space beam with a diameter of several wavelengths to a diffraction limited spot size while simultaneously providing small semi-aperture and ease of manipulation. A high refractive index semiconductor waveguide with a tapered section disposed at the end of a cantilever accomplishes this spatial confinement up the ultimate diffraction limit with minimal angular semi-aperture and near unity efficiency.

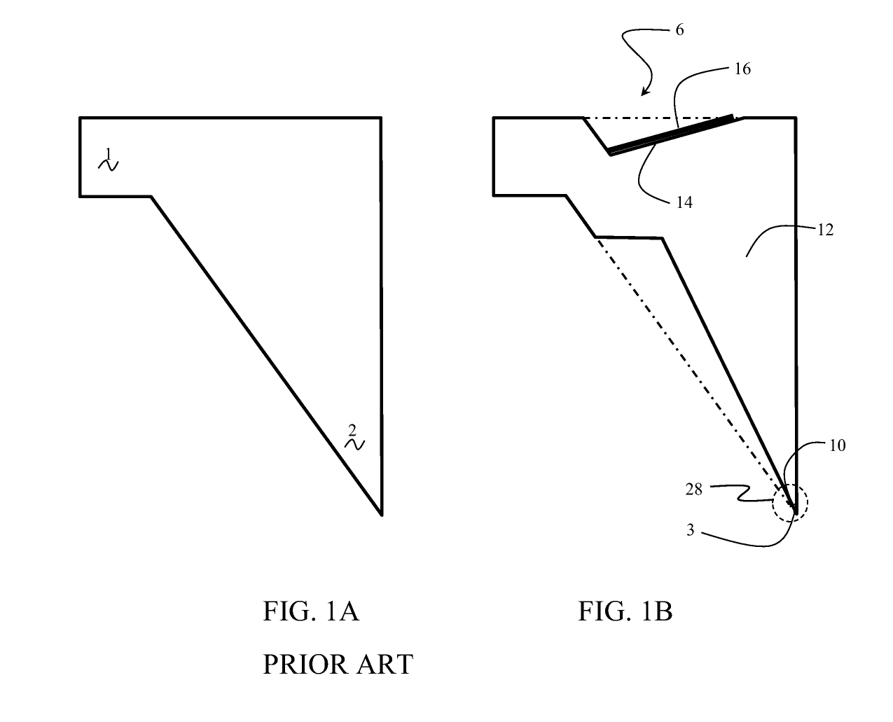

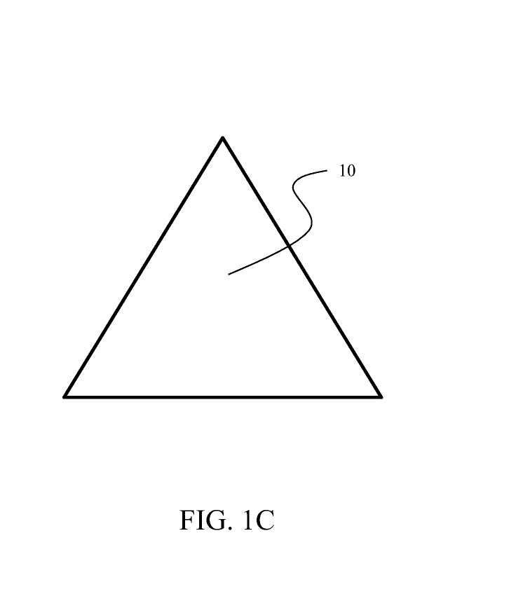

Referring to the drawings, FIG. 1A shows a standard tetrahedral silicon AFM probe, with a cantilever 1 and a tip 2. This standard silicon AFM probe design is not intrinsically useful for optical microscopy because the top surface is not orthogonal to the tetrahedral axis thereby leading to total internal reflection instead of external refraction. It also strongly couples light from the tip 2 into the cantilever 1. Light which is coupled into the cantilever lowers efficiency of the waveguide.

FIG. 1B shows a first embodiment of a near field optic 6 in which an end section 3 (shown in phantom) is removed from a silicon AFM probe to form the near-field facet 10, a the side section 4 (shown in phantom) is removed to form a waveguide taper 12, and a top section 5 (shown in phantom) is removed to form a first face as a far-field facet 14. The near-field facet 10 has an equilateral triangular shape as shown in FIG. 1C and an area that supports only one optical mode per polarization. The waveguide taper 12 remains tetrahedral with the side section removed, but has a reduced taper angle relative to the originally etched structure. The top far-field facet 14 is substantially orthogonal to the incident light. A simple anti-reflection coating 16 of silicon nitride of approximately 160 nm thickness can be deposited on the far-field facet. Forming of the facets is accomplished in an exemplary embodiment by shaping the waveguide using a Focused Ion Beam (FIB) milling.

For the embodiment shown, the near-field optic 6 has a heterogeneous high refractive index material with waveguide surfaces and two facets. The far-field facet 14 may be a planar if the numerical aperture is low enough that aberrations are insignificant. In the case of silicon, the quarter wave anti-reflection coating 16 of silicon nitride can reduce the back-reflection from the far-field facet to less than a percent, thereby improving the efficiency by more than thirty percent. Total internal reflection at the waveguide surfaces guides the fundamental mode transformation, without introducing significant loss, between the large area of the far-field facet and the tight spatial confinement of the near-field facet. The optical confinement of 1300 um NIR light propagating from dipole radiation at the near-field facet 10 and propagating to the far-field facet 14 and exiting the near field optic 5 as near planar radiation. Other coatings or structures may be employed to enhance the efficiency of coupling. Furthermore, alternative material choices for the near-field optical waveguide can be used such as Gallium Phosphide or Silicon Nitride or many other types depending upon the ease of manufacturing such a probe or the type of application or the wavelength of the probe. For instance, shorter, visible wavelengths can be used with the near field optic and although Silicon may be used, its absorption of the higher energy light may suggest using a higher bandgap material or an insulator such as silicon nitride.

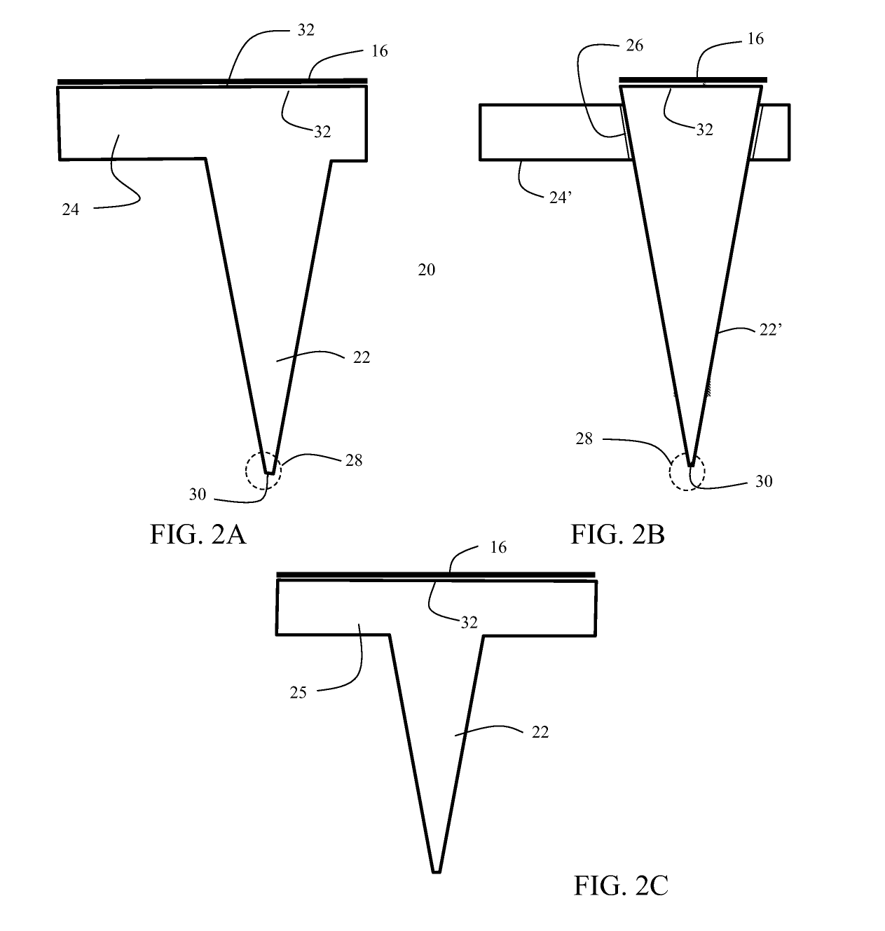

Refinement of the embodiment disclosed in FIGS. 1B and 1C may be accomplished by fabricating custom probe to provide a near-field optic 20 with a right or orthogonal waveguide 22 oriented vertically. Waveguide 22 may employ a conical taper. An exemplary embodiment has a monolithically fabricated cantilever 24 as a support for the waveguide 22, as illustrated in FIG. 2A. However, in an alternative embodiment, a conical near-field optic 20′ is mounted in a separately fabricated cantilever 24′ with an aperture 26 to receive the waveguide 22′, as illustrated in FIG. 2B. As in the initial embodiment, the near field optic incorporates a near field facet 30 and a far field facet 32 both substantially orthogonal to the incident light with a simplified geometric structure due to the orthogonal conical waveguide taper 22, 22′. An antireflection coating 16 may be employed on the far field facet as in the prior embodiment.

Support of the near-field optic may take alternative forms in addition to a cantilever. A beam, plate, membrane, and other such support geometries, which are commonly used for support of a probe in atomic force microscopy and MEM/NEMS field maybe employed. A general cross section of these alternatives is shown in FIG. 2C wherein the support 25 extends across a gap in the silicon support structure.

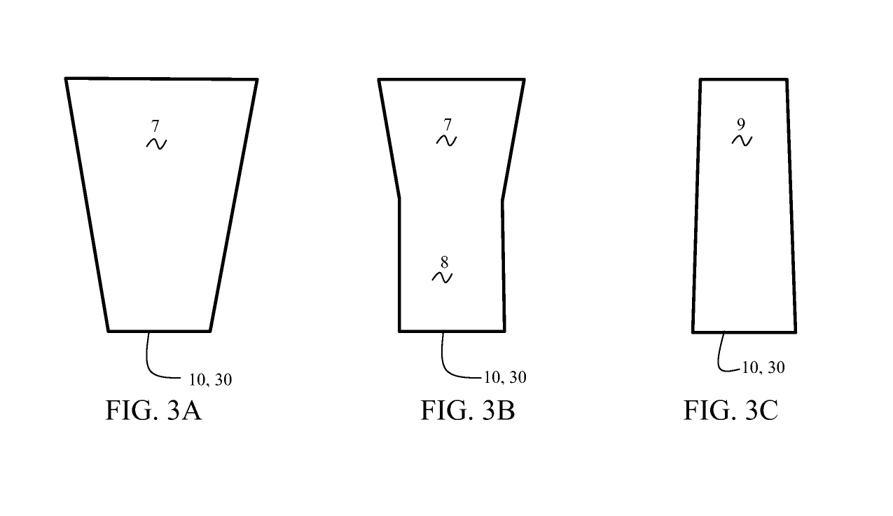

Further improvement of the efficiency of the near field optic is accomplished by modification of the taper of the waveguide proximate the near field optic generally shown as zone 28 in FIGS. 1A, 1B, 2A and 2B. As shown in FIG. 3A, the standard linear taper 7 will permit coupling of light into the side of the waveguide close to the near-field facet 10, 30. Coupling of light not from the near-field facet or far-field facet is an undesirable effect. In order to reduce this background light and generate better spatial isolation, a short untapered section of waveguide 8 illustrated in FIG. 3B in the optical near-field, prevents light from coupling into the side of the waveguide. This short untapered section may be considered to extend from the near-field facet to outside of the near-field optical domain. The taper transition may also take on a quadratic functionality until the diverging tapered slope is met, in order to prevent unnecessary scattering of the fundamental mode. A further alternative, illustrated in FIG. 3C is using an inverse linear taper 9 to couple the light into air with low numerical aperture. Other shapes or small modifications to the present embodiments are included in the scope of this disclosure.

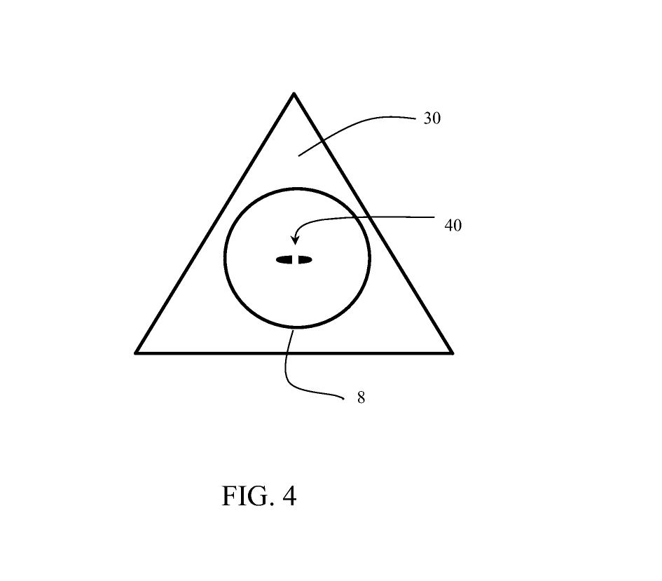

An additional embodiment adds an optical antenna to allow strong spatial confinement of light entering the near field facet by more effective/efficient means rather than tapered optical fibers or large, near-field elements such as large semi-aperture designs of the prior art. Great improvements over such designs can be achieved by disposing an optical antenna 40 on the near field facet 30 of the high index tapered near-field nano-optic 20, 20′, as shown in FIG. 4 in order to maximize the overall coupling efficiency. As will be described in greater detail subsequently, the optical antenna 40 is formed from a gold nanorod adhered to the near field facet 30 and bifurcated to form the antenna dipole. The optical antenna which is disposed on the near-field facet of the waveguide of the first embodiment provides the remaining spatial confinement with reasonably high efficiency. In order to maintain maximum efficiency, no metal coating is used and the wave guide is proportioned such that the guiding mechanism is refractive index contrast. Although some designs of the prior art include antenna elements disposed on tapered optical fibers, which provide a first element comprising confinement and a second element comprising an antenna, these designs provide poor efficiency do to the low index fiber and therefore poor confinement in the fiber. Furthermore, designs of the prior art often use poly crystalline metal antenna materials which further reduce efficiency due to high resistive losses as optical frequency plasmons propagate across grain boundaries.

The optical antenna on the near-field facet of the high index waveguide couples light between the diffraction limited spot size and the nanometer-scale object. The antenna length is chosen so that it will be in resonance with the compressed wavelength at the near-field side of the waveguide. This design is ultimately limited by the losses in the optical antenna, which are minimized by reducing the diffraction limited spot size and using monocrystalline noble metal, gold in the exemplary embodiment. The length of a dipole optical antenna needed to achieve resonance is significantly reduced, for example 30%, in the presence of the high refractive index waveguide, which further improves the efficiency. Efficiency and therefore performance of the antenna is enhanced by squeezing light as far as practicable using the waveguide before coupling to the antenna. The smaller the antenna, the lower the losses in the antenna and therefore the more signal can be coupled to and from the nanoscale object. The result of this combination is improved signal to noise ratio in the measurement.

The waveguide area at the near-field facet operates below the cutoff condition where only a single optical mode exists per polarization for several reasons. For example in a cylindrical waveguide, when the V number, as is well known in the field of fiber optics, is below 2.405. The first reason is that the spatial confinement of the fundamental mode is highest when in single mode operation. The second reason is that the strong polarization asymmetry of the fundamental mode overlaps well with the optical antenna area providing optimal coupling of photons into plasmons. A third reason is that minimizing the end area of the probe provides closer proximity to the object and less mechanical interference to adjacent parts of the object, if they exist. Decreasing the waveguide area below this cutoff marginally improves the spatial confinement but also decreases the effective index of the waveguide and its associated overall coupling efficiency. The waveguide shape in the near field zone 28 may be polygonal, circular, or elliptical shape which after tapering becomes pyramidal or conical. For rectangular and triangular waveguides the near field zone 28 (the part of the waveguide adjacent to the near field facet) may be dimensioned to support only a single optical mode for structures with one polarization or a single optical mode for each polarization in structures with dimensions in which multiple polarizations are supported. The dimensions of the polygonal waveguide are defined by numerical analysis to support only the fundamental mode for each polarization. In an exemplary embodiment for a wavelength of 1064 ηm a waveguide having rectangular dimensions of 130 ηm by 300 ηm in the near field zone, as determined by numerical analysis, may be employed.

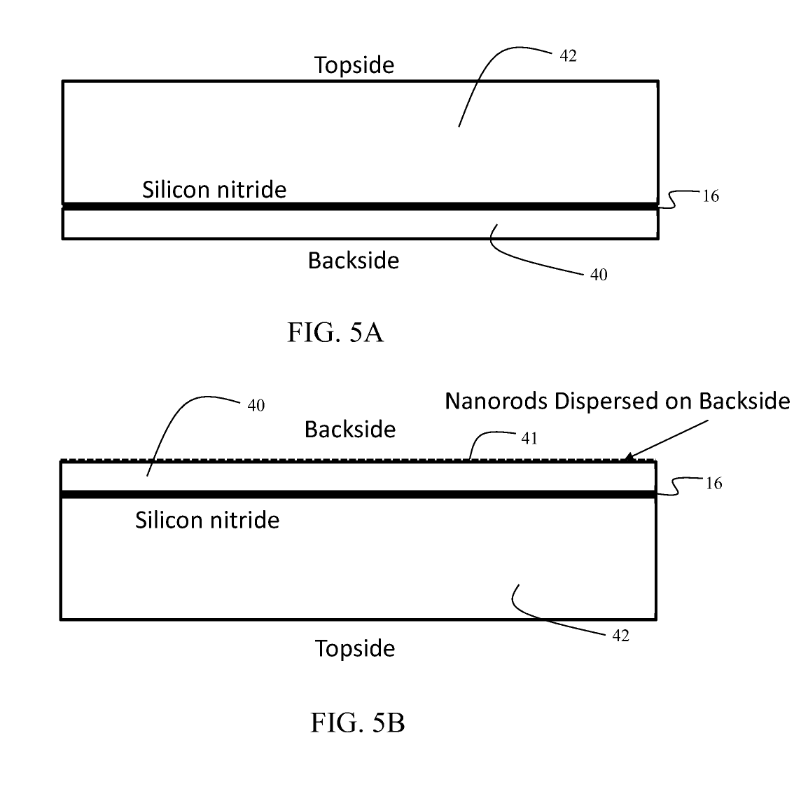

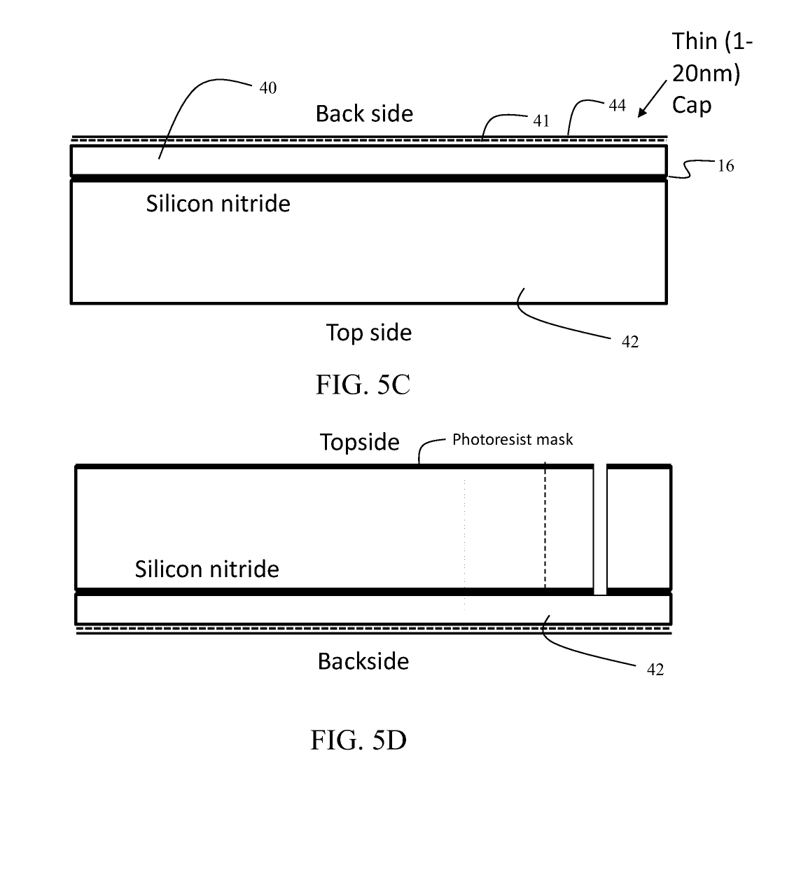

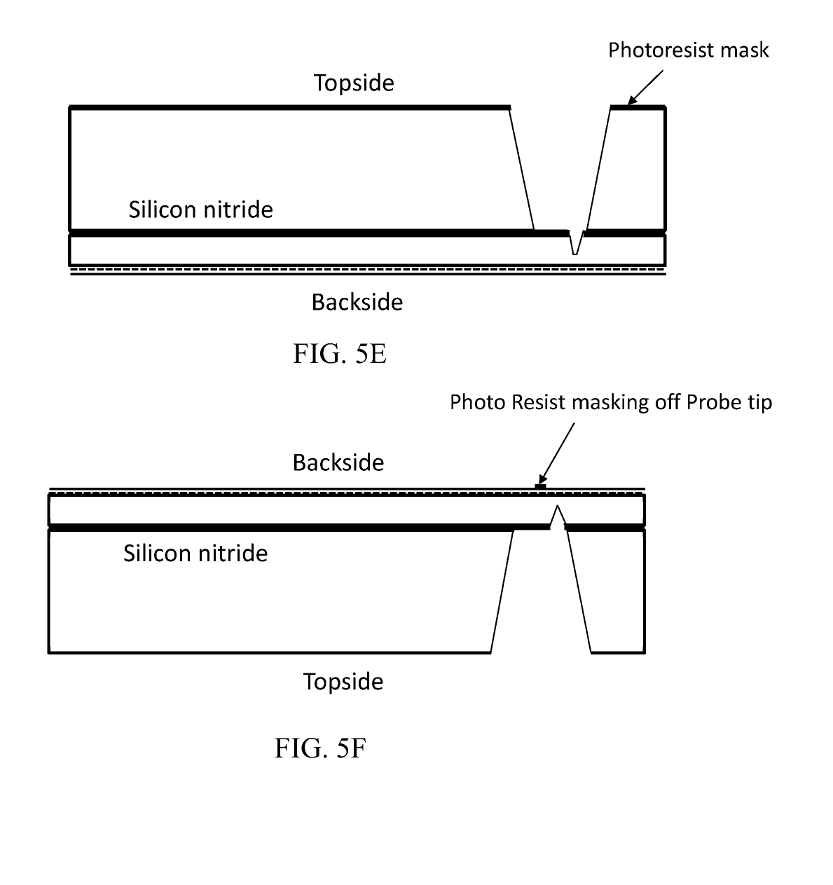

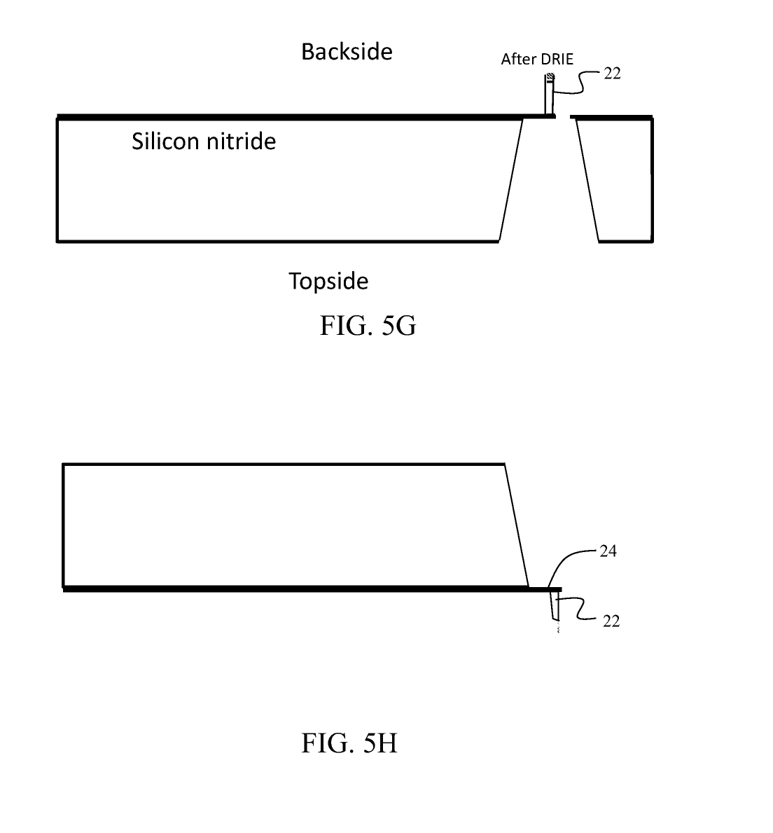

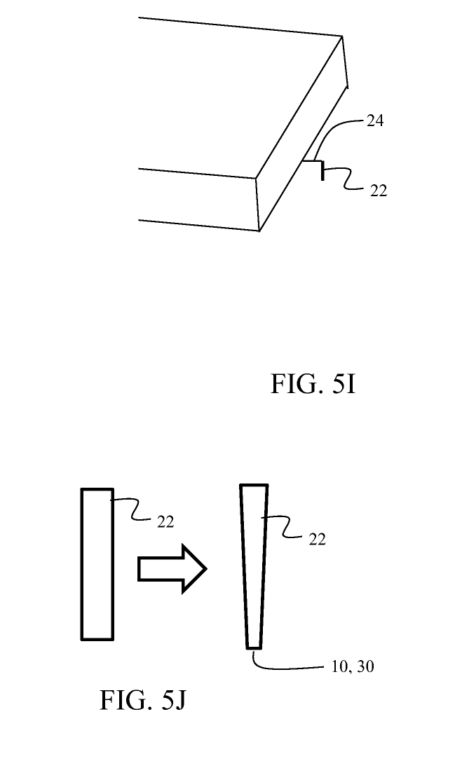

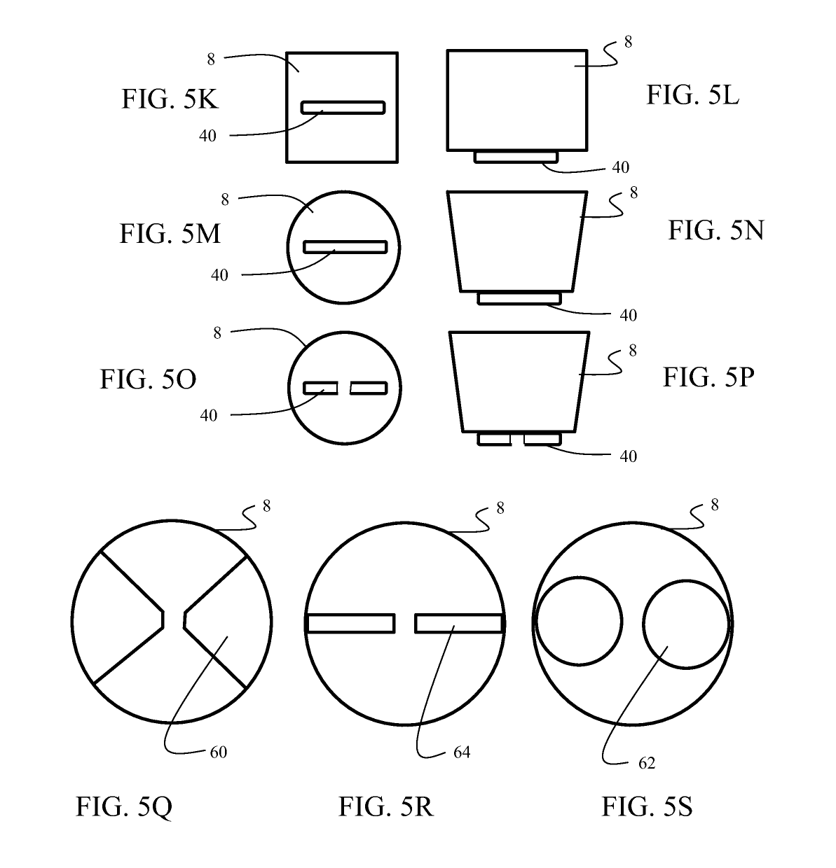

A method for fabrication of a near field optic according to the described embodiments is discussed with respect to FIGS. 5A-5P. As illustrated in FIG. 5A, planar anti-reflection coating of silicon nitride 16 is grown or deposited on a double side polished oriented silicon wafer 40. A second silicon wafer 42 is then bonded to the silicon nitride 16. The dividing Silicon Nitride layer will double as antireflection coating and cantilever, as will be described subsequently. A solution layer containing gold nanorods 41 may be dispersed on what will become the near field facet of the near field optic as shown in FIG. 5B. A thin (1-20 nm) capping layer and sacrificial layer 44 are then deposited on that surface of the wafer as shown in FIG. 5C. The stack is at this point prepared for micro-fabrication. An area is masked on the sacrificial layer 44 at the tip locations, and the sacrificial layer, capping layer, and nanorods in the unmasked regions are etched away exposing the silicon wafer 42 as shown in FIG. 5D. Patterning and removal of silicon above the cantilever with KOH dip terminating on the nitride is accomplished as shown in FIG. 5E. A Photo Resist pattern for the 10 um round waveguide cylinders is applied to mask off the probe tip as show in FIG. 5F. Deep RIE to create the probe tip geometry with an etch stop on the buried nitride layer is then accomplished as show in FIG. 5G. Shaping of the probe tip then results in a configuration for wave guide 22 and support 24 as shown in FIGS. 5H and 5I. Shaping of the probe tip is accomplished as shown in FIGS. 5J-5P.

The remaining sacrificial layer 44 is removed once all etching is completed. If the optic is to include an optical antenna a FIB or SEM is used to locate a nanorod 40 within the tip area by topography or by material contrast as represented in FIGS. 5K and 5L. The FIB is then used to mill the untapered and tapered waveguide sections around it from the pyramidal shape, as illustrated in FIGS. 5M and 5N forming the untapered portion of the waveguide 8. The FIB then cuts the nanorod 40 in half forming the dipole optical antenna and gap, as illustrated in FIGS. 5O and 5P and shown and discussed previously in FIG. 4 and trims the dipoles, if necessary, from the ends to shift the resonance frequency. If the near field optic is not optical antenna enabled, the etching process can be monolithically defined to product a near-field facet end shape as defined by the taper and wavelength as discussed above.

In alternative embodiments the optical antenna is a Bow-tie 60 as shown in FIG. 5Q, a Hertzian dimer 62 as shown in FIG. 5S, split ring, and other optical antenna shapes, as well as non-resonant sizes of the same shapes as shown in FIG. 5R, for a non-resonant linear dipole 64.

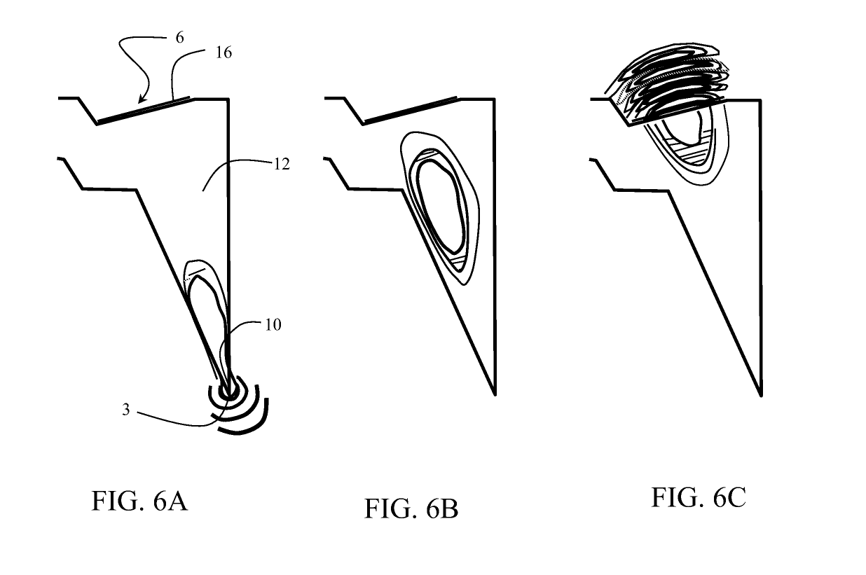

FIGS. 6A-C shows a representation of a Finite Difference Time Domain (FDTD) simulation demonstrating 1300 nanometer wavelength dipole emission is primarily coupled through the near-field facet of an exemplary embodiment as shown in FIG. 6A, transmitted across the tapered section transforming the fundamental mode as shown in FIG. 6B, exiting the far-field facet into free space as shown in FIG. 6C. The total height of the probe for the example in FIGS. 5A-5C is 17.5 micrometers. The beam area at the far-field facet is about 4 micrometers. The low taper angle leads to low numerical aperture and permits use of a simple planar interface on the far-field facet without introducing significant aberration.

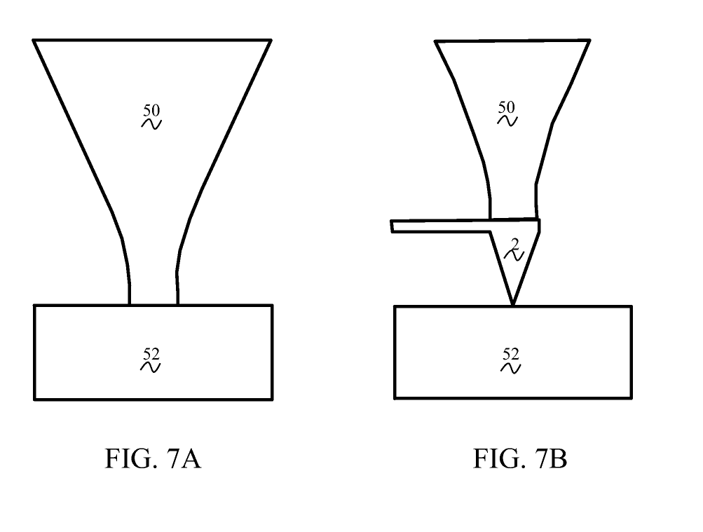

FIG. 7A shows the standard method of using the far-field optics in a SOM to localize features of an object where the focused optical beam 50 is rastered on an area of the object 52. In FIG. 7B higher resolution is obtained with an embodiment of the present invention that introduces a scanning near-field optic 2 while the optical beam 50 couples the fundamental free space optical mode into the far field facet while the near field facet couples the reduced optical mode into the object 52. The embodiments disclosed may employ the use of force feedback. This force feedback may be any mode as is known in the art of scanned probe microscopy such as contact, shear-force, intermittent contact, non-contact, or other type. Furthermore, if the oscillation amplitude of one of the AC techniques is significantly less than the evanescent decay length, the resolution is not strongly affected while the probe may be scanned using the optimal feedback mode with little to no wear to the near field facet. Furthermore, the oscillation amplitude, phase, and frequency may be detected in the SOM as a carrier signal or the feedback optical signal may be at an alternative wavelength which does not couple into the nano-optic but is instead reflected to a detector.

Having now described various embodiments of the invention in detail as required by the patent statutes, those skilled in the art will recognize modifications and substitutions to the specific embodiments disclosed herein. Such modifications are within the scope and intent of the present invention as defined in the following claims.

What is claimed is:

1. A near-field optic comprising:
a high refractive index waveguide with a first face for coupling light propagating in free space,
a near field facet on the waveguide wherein a near field zone of the waveguide supports only a fundamental optical mode for each polarization;
a tapered waveguide section to transform the fundamental optical mode between said near field facet and said first face; and,
a support capable of supporting the near field facet of said near-field optic within the evanescent decay length of an object.

2. The near-field optic of claim 1 with an additional continuous waveguide section extending from the near-field facet to outside of the near-field optical domain.

3. The near-field optic of claim 1 with an optical antenna on said near-field facet.

4. The near-field optic of claim 3 wherein the optical antenna is a dipole.

5. The near-field optic of claim 4 wherein the dipole is formed from a bifurcated gold nanorod.

6. A near-field optic comprising:
a high refractive index waveguide with an inverse tapered section supported by a cantilever and adapted to transform the fundamental optical mode from propagating to confined; and,
a facet in the near-field that supports only the fundamental optical mode.

7. A method for fabricating a near-field optic comprising:
milling a tetrahedral silicon AFM probe at an end section to form a near field facet;
milling the probe to remove a side section forming a waveguide taper;
milling the probe on a top surface to form a far field facet substantially orthogonal to incident light.

8. The method of claim 7 further comprising depositing an antireflection coating on the far field facet.

9. A method for fabricating a near-field optic comprising:
depositing silicon nitride on a double side polished oriented silicon wafer;
bonding a glass carrier wafer to the silicon nitride;
depositing a capping layer and sacrificial layer on a surface of the wafer opposite the silicon nitride;
masking an area on the sacrificial layer at tip locations;
enticing and the sacrificial layer and capping layer in the unmasked regions exposing the silicon wafer;
Anisotropic wet etching to form four-sided pyramids around the tip locations with a flat bottom, which is timed to determine the thickness of cantilever;
pattern and remove sections of the glass carrier wafer and pattern and release the cantilever and tip, waveguide taper;
remove the remaining sacrificial layer once all etching is completed.

10. The method of claim 9 further comprising dispersing gold nanorods on what will become the near field facet of the near field optic.

11. The method of claim 10 further comprising:
using a FIB or SEM to located a nanorod within the tip area by topography or by material contrast;
milling the untapered and tapered waveguide sections around the nanorod from the pyramidal shape;
cutting the nanorod in half forming the dipole optical antenna and gap.

12. The method of claim 11 further comprising trimming dipoles of the optical antenna from the ends to shift the resonance frequency.

13. A method for operation of a near field optical microscope comprising:
coupling light propagating in free space into a high refractive index waveguide with a first face through a near field facet supporting only the fundamental optical mode;
transforming the fundamental optical mode between said near field fact and said first face in a tapered waveguide section;
supporting the near field facet of said near-field optic within the evanescent decay length of an object; and,
oscillating the nano optic in either non-contact mode force feedback or intermittent contact mode with an oscillation amplitude on the order of the evanescent field decay length or smaller.
